(19) United States
(12) Patent Application Publication
(10) Pub. No.: US 2014/0196436 A1
(43) Pub. Date: Jul. 17, 2014

(54) OPERATION STABILIZATION METHOD AND OPERATION STABILIZATION APPARATUS FOR SUPERSONIC INTAKE

(71) Applicant: JAPAN AEROSPACE EXPLORATION AGENCY, Tokyo (JP)

(72) Inventor: Yasushi Watanabe, Chofu-shi (JP)

(73) Assignee: JAPAN AEROSPACE EXPLORATION AGENCY, Tokyo (JP)

(21) Appl. No.: 14/155,472

(22) Filed: Jan. 15, 2014

(30) Foreign Application Priority Data
Jan. 17, 2013 (JP) 2013-006354

(51) Int. Cl. F02K 1/38

(52) U.S. Cl. CPC F02K 1/38
USPC 60/204; 60/224

(57) ABSTRACT

An object of the present invention is to provide a technique of enlarging a stable operating range of an intake in accordance with an operating condition of an engine without using a complicated control system so that a wide operating range of the engine can be covered. In an operation stabilization method for a supersonic intake according to the present invention, an enlarged duct between a cowl and a ramp of the intake is divided by a splitter plate such that an opening angle of the enlarged duct decreases. Further, in the operation stabilization method for a supersonic intake according to the present invention, when the duct is divided by the splitter plate, the splitter plate is disposed such that, from among a cowl side duct and a ramp side duct, cross-section variation in one duct, in which an effect of a flow is larger, is reduced within an allowable range of total pressure loss in the other duct.

### BACKGROUND OF THE INVENTION

1. Field of the Invention

The present invention relates to a technique for stabilizing an operation of an air intake port (a supersonic intake) of a propulsion system for a supersonic aircraft.

2. Description of the Related Art

When a flow balance between an operating condition of an engine and an air intake port (a supersonic intake) is disrupted in a propulsion system of a Mach 2 class supersonic passenger aircraft, a hydrodynamically unstable flow is generated, and as a result, an operation of the engine is restricted. The propulsion system of a supersonic aircraft, as shown in an upper section of FIG. 8, is configured such that the engine and also a nozzle are disposed on a downstream side of the air intake port (the supersonic intake). This technique of controlling the flow balance was employed on the Concorde, among conventional passenger aircraft. In a method employed in the related art, as shown in more detail in a lower section of FIG. 8, a ramp of the intake is constructed by interposing two variable mechanisms (a first variable ramp and a second variable ramp) between front and rear fixing regions so as to oppose each other via a slit, and the flow balance is realized by controlling a flow flowing into the intake in accordance with the operating condition of the engine (see Intake of Concorde in AIAA Professional Study Series, J. Rech and C. Leyman, “A Case Study by Aerospatiale and British Aerospace on the Concorde”, Section 6, and Intake of JAXA Experimental Aircraft in Procof ICAS 2006, Watanabe Y, Murakami A, “Control of Supersonic inlet with Variable Ramp” (paper presented by Japan Aerospace Exploration Agency)).

In other words, it may be said that the control technique disclosed in the aforesaid documents is a control technique for keeping the operating condition of the intake constant relative to flow variation required by the engine. However, this conventional method includes two main problems. One of these problems is that all conditions required for control of the intake must be satisfied during airframe development. The other problem is that a system required for the control is complicated. To describe the first problem in further detail, it is necessary for intake control to implement following procedures: 1) setting a physical quantity (that can be monitored) expressing the operating condition of the intake; 2) implementing a wind tunnel test for associating the operating condition with the physical quantity and storing results on a database; and 3) creating a control law and incorporating the control law into the engine control system. As a result, development requires a great deal of labor and expense.

As regards the latter problem, in addition to a normal system, it is necessary to design 1) a system for monitoring the operating condition of the intake, and 2) a system (a variable ramp system) for controlling the operating condition of the intake. Since the system employed in the related art is complicated, a great deal of time and money must be spent on development of these systems to ensure reliability.

A further intrinsic problem of the related art is that a stable operating range of the intake cannot cover an operating range of the engine. Two types of instability phenomena occur in the intake. One type is an unsteady phenomenon (known as buzz) that accompanies shock wave oscillation and occurs when the engine decelerates, leading to a reduction in the flow, and the other type is an unstable flow caused by extreme growth in a boundary layer, which occurs when the engine accelerates, leading to an increase in the flow. The stable operating range of the intake can therefore be enlarged by suppressing the occurrence of these two types of instability phenomena.

### SUMMARY OF THE INVENTION

In consideration of the problems described above, an object of the present invention is to provide a technique of enlarging a stable operating range of an intake in accordance with an operating condition of an engine without using a complicated control system so that a wide operating range of the engine can be covered.

In an operation stabilization method for a supersonic intake according to the present invention, an enlarged duct between a cowl and a ramp of the intake is divided by a splitter plate such that an opening angle of the enlarged duct decreases. Further, in the operation stabilization method for a supersonic intake according to the present invention, when the duct is divided by the splitter plate, the splitter plate is disposed such that, from among a cowl side duct and a ramp side duct, cross-section variation in one duct, in which an effect of a flow is larger, is reduced within an allowable range of total pressure loss in the other duct.

In an operation stabilization apparatus for a supersonic intake according to the present invention, a splitter plate that divides an enlarged duct between a cowl and a ramp of the intake is disposed on a downstream side of a bleed slit such that an opening angle of the enlarged duct decreases.

In one aspect of the operation stabilization apparatus for a supersonic intake according to the present invention, the splitter plate is disposed such that the opening angle of the enlarged duct is equal on the cowl side and the ramp side of the intake.

In another aspect of the operation stabilization apparatus for a supersonic intake according to the present invention, the splitter plate is disposed such that, from among a cowl side duct and a ramp side duct, cross-section variation in one duct, in which an effect of a flow is larger, is reduced within an allowable range of total pressure loss in the other duct.

With the operation stabilization method and operation stabilization apparatus for a supersonic intake according to the present invention, the enlarged duct of the intake is divided by the splitter plate, and therefore a fluid separation phenomenon can be prevented from occurring in a diffuser. As a result, the stable operating range of the intake can be enlarged. Moreover, a complicated control system such as that of the related art, as well as design and development thereof, are not required, and therefore the stable operating range of the intake can be enlarged using a simple structure in which the enlarged duct of the intake is divided by disposing the splitter plate therein.

Further, in the operation stabilization apparatus for a supersonic intake according to the present invention, variation in the duct in which the effect of the flow is larger, from among the cowl side and ramp side ducts, is reduced within the allowable range of the total pressure loss in the other duct, and therefore a wide operating range of the engine can be covered more effectively.

### BRIEF DESCRIPTION OF THE DRAWINGS

FIG. 1 is a view showing a structure of a supersonic intake;

FIG. 2 is a view showing Schlieren images of shock wave patterns in four conditions of an intake portion in an upper section, and total pressure distributions of an intake outlet at corresponding times in a lower section;

FIG. 3 is a graph showing an amount of variation in the total pressure of the intake outlet relative to amass flow of air flowing through an engine;

FIG. 4 is a view showing arrangements of a splitter plate according to the present invention, wherein FIG. 4A shows a case in which a cowl side duct is made substantially rectilinear and FIG. 4B shows a case in which the duct is simply divided equally;

FIG. 5 is a graph showing pressure variation in an inflow relative to the operating condition of the engine, comparing characteristics of the present invention and a conventional apparatus;

FIG. 6 is a view showing distributions of an RMS value of the overall pressure variation at each stage in the present invention and the conventional apparatus;

FIG. 7 is an airframe model at a proposal stage, to which the present invention can be applied as a future concept; and

FIG. 8 is a view illustrating a configuration of a propulsion system of a conventional supersonic aircraft.

### DESCRIPTION OF THE PREFERRED EMBODIMENTS

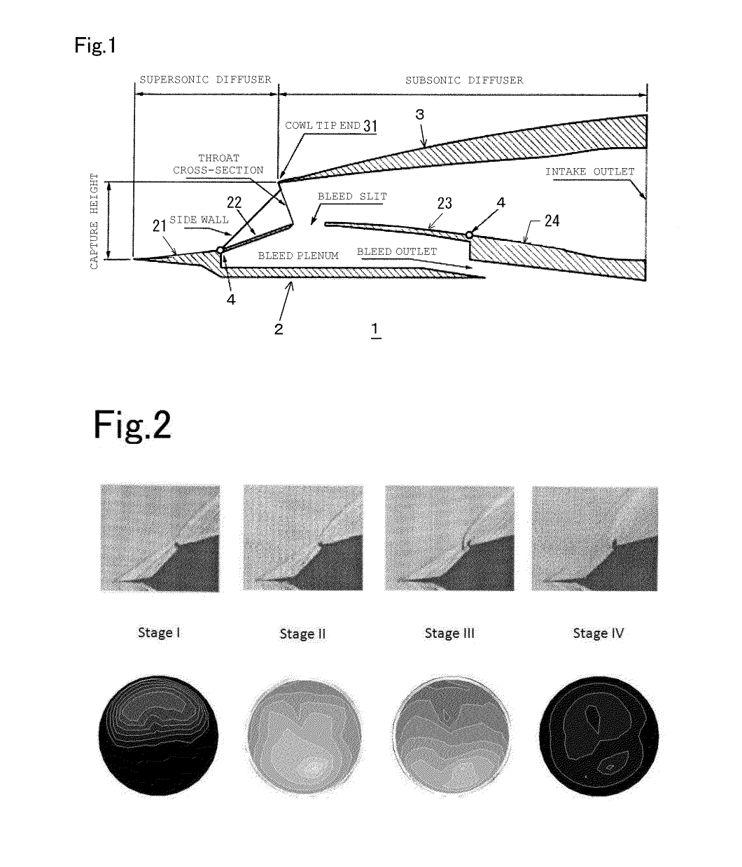

Before describing the present invention, FIG. 1 shows a structure of a supersonic intake. 1 denotes an overall structure of the intake (an air intake port), 2 denotes a ramp, and 3 denotes a cowl. The ramp 2 is constituted by a fixed first ramp 21, a variable-structure second ramp 22 joined by a hinge to a rear end portion of the first ramp 21, a rearward fixed ramp 24, and a variable-structure third ramp 23 joined by a hinge to a tip end portion of the fixed ramp 24, wherein a bleed slit is formed between variable tip end portions of the second and third ramps. As a fixing structure for the cowl 3, an upstream side of the cowl 3 serves as a cowl tip end portion 31, and a throat cross-section is formed by the cowl tip end portion 31, the second ramp 22, and a side wall. Operating conditions of the intake at supersonic speeds will be classified and described below in accordance with experiment data obtained using this model. As shown in the drawing, the intake 1 includes the two-stage ramp 2, and variable mechanisms are applied to the second ramp 22 and the third ramp 23. In a case where a second ramp angle is at a nominal value (12.0 deg) under a flight condition according to which a ramp shape has a design Mach number of 2.0, an opening area ratio of a diffuser in the throat cross-section and an intake outlet is 2.0, and a length ratio of a subsonic diffuser having a diameter of the intake outlet as a reference is 3.3.

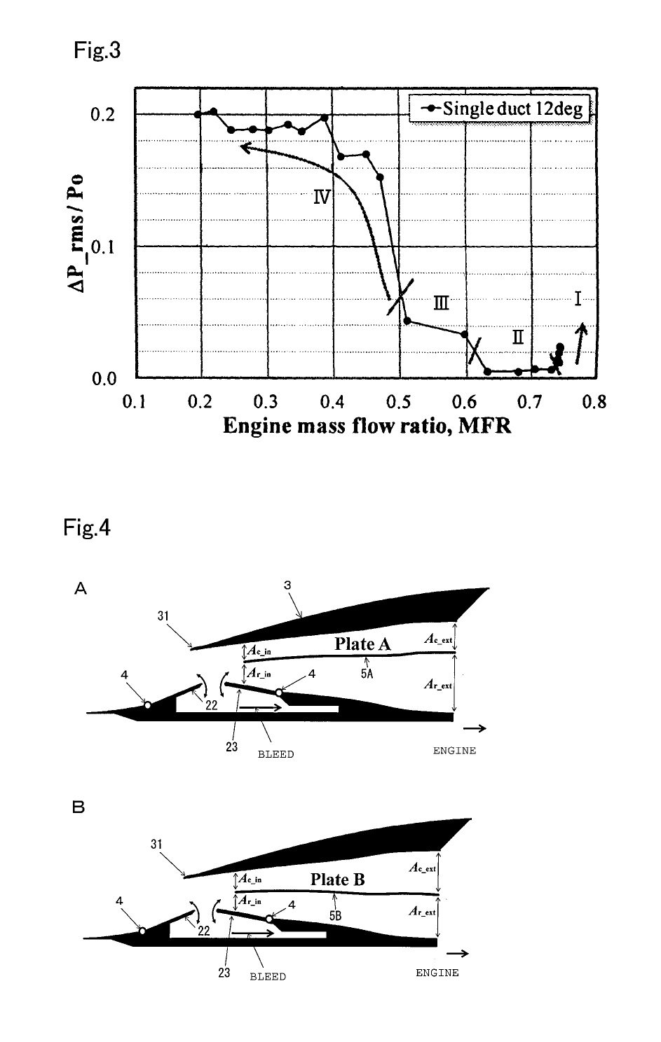

FIGS. 2 and 3 show an aerodynamic performance and a flow field when the operating condition of the intake is varied from the condition described above. The operating condition of the intake can be classified into four conditions according to characteristics thereof. An upper section of FIG. 2 shows Schlieren images of shock wave patterns in the four conditions of the intake portion, and a lower section of FIG. 2 shows total pressure distributions of the intake outlet at corresponding times. In the drawings, the condition deteriorates as the color darkens. A graph in FIG. 3 shows an amount of variation in the total pressure of the intake outlet relative to a mass flow of air flowing through an engine. A first operating condition is a supercritical operating condition shown in Stage I of FIG. 2. In this condition, a flow that can be ingested by the engine is larger than a flow captured by the intake, and therefore, as is evident from FIG. 2, the total pressure decreases due to flow separation and so on. Further, as shown in FIG. 3, total pressure variation increases, leading to large temporal variation in a relationship between a circumferential direction distortion index and a radial direction distortion index indicating the total pressure distribution. As a result, an operation of the engine may be restricted.

A second condition, indicated by Stage II, is a condition in the vicinity of a critical operating condition of the intake in which the total pressure is high and an outlet pressure distribution is even such that temporal variation in the total pressure and the distortion indices is small. It may therefore be said that in this condition, the engine can be operated sufficiently.

A third condition, indicated by Stage III, is known as Ferri buzz. In this condition, a shear layer flows into the subsonic diffuser from an intersection between a diagonal shock wave generated from the second ramp and a final shock wave, leading to appearance of a shock wave oscillation phenomenon. Total pressure loss due to the shock wave is large on the cowl side (the upper side in FIG. 2) of the shear layer, and therefore the total pressure decreases. Further, temporal variation in the total pressure and the distortion indices accompanying the shock wave oscillation is large, and therefore a normal engine operation is not guaranteed. The occurrence of Ferri buzz depends on the strength of the inflowing shear layer, and therefore, in the intake serving as the subject of the present research, Ferri buzz occurs only when a flight Mach number condition is approximately Mach 1.8 or higher.

Finally, in a fourth operating condition indicated by Stage IV, a shock wave oscillation phenomenon having an extremely large amplitude known as Dailey buzz occurs. In this condition, extremely large total pressure variation occurs, and therefore this condition must be avoided reliably in order to operate the engine.

Hence, a sufficient engine operation can be guaranteed only in the condition of Stage II, and therefore, taking a jet-powered experimental aircraft as an example, the stable operating region described here can only respond to approximately 5% variation in an engine rotation speed. It must therefore be said that a stable operating region of the intake is extremely narrow in terms of the engine operation. Hence, to enlarge the stable operating region in accordance with the object of the present invention, it is necessary not only to enlarge the Stage II condition by shifting respective occurrence points of Stage III (Ferri buzz) and Stage IV (Dailey buzz) to a lower flow side, but also to suppress temporal variation in the total pressure and the distortion indices in Stage I and either suppress the occurrence of Ferri buzz or reduce the total pressure variation resulting therefrom in Stage III.

As described above, to enlarge the stable operating region of the intake, it is necessary to suppress the occurrence of Ferri buzz and turbulence in the supercritical operating condition. These problems are believed to be essentially due to flow separation in the diffuser, and therefore a diffuser duct in which flow separation is unlikely to occur must be considered. To stabilize the diffuser flow in a condition where the opening area ratio is fixed, it is effective to reduce an opening angle of the duct. This can be achieved easily by lengthening the duct, but in so doing, problems such as an increase in structural weight and a reduction in freedom when integrating the airframe propulsion system arise. In the present invention, therefore, the opening angle is reduced by inserting a splitter plate into the diffuser duct in order to divide the duct. in a case where a shear layer that causes Ferri buzz flows in, it has been reported that buzz does not occur when the shear layer flows into a rectilinear duct. Hence, effects of experiments in which a splitter plate (referred to hereafter as Plate A, see FIG. 4A) is inserted such that a cowl side duct becomes substantially rectilinear and a splitter plate (referred to hereafter as Plate B, see FIG. 4B) is inserted such that the duct is simply divided equally have been investigated in order to obtain a strategy for application to the intake.

In the present invention, as shown in FIG. 4, the problems described above are solved by providing a splitter plate 5 in the intake duct such that the opening angle of the duct is reduced and the duct is shortened in a balanced manner. As a basic dividing method, the duct is divided equally, as shown in FIG. 4B. Due to characteristics of the intake, however, the causes of instability phenomena are often biased to one side wall. Therefore, in a case where the causes of instability are biased toward the cowl tip end side, for example, a method of dividing the duct such that the cowl tip end side becomes rectilinear and only the ramp side duct is provided with an opening angle, as shown in FIG. 4A, is employed.

Note that the operation stabilization method according to the present invention is a duct division method based on the hydrodynamic knowledge described above, while the operation stabilization apparatus denotes the duct divided by the splitter plate itself.

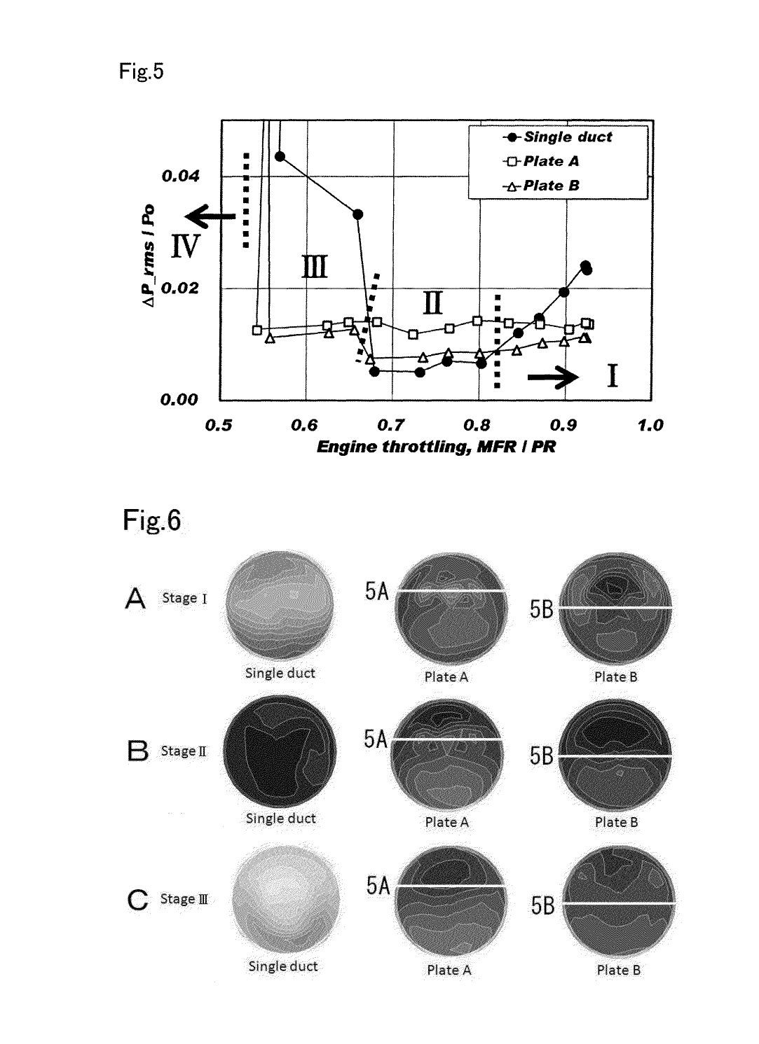

FIG. 5 is a graph showing enlargement of the stable operating region achieved by the present invention, to which the duct division (Plate A, Plate B) of FIG. 4 is applied, relative to a variable ramp control method according to the related art (Procof ICAS 2006, Watanabe Y, Murakami A, “Control of Supersonic Inlet with Variable Ramp” (paper presented by Japan Aerospace Exploration Agency): Single duct). An ordinate of the graph shows an RMS value of pressure variation in the flow flowing into the engine, wherein a smaller value indicates a more stable flow. An allowable limit of the variation differs according to the engine, but since the shock wave oscillation (buzz) described above is typically not permitted, an allowable range set on the basis of this fact, in which the value on the ordinate is no larger than approximately 0.02, is considered appropriate. An abscissa shows a parameter corresponding to the engine rotation speed, wherein a larger value indicates a higher rotation speed corresponding to an operating condition in which a larger flow is required. In the supercritical operating condition, a flow ratio is constant, and therefore the operating condition cannot be expressed by the flow ratio. Accordingly, a value obtained by dividing a flow ratio MFR corresponding to the operating condition of the engine by a pressure recovery rate PR is used on the abscissa. In so doing, variation differences in the supercritical operating region due to insertion of the splitter plate can be expressed clearly. Further, FIG. 6 shows a distribution of the RMS value of the total pressure variation at each stage. In the drawing, darker colors indicate more preferable conditions. It is evident from the graph in FIG. 5 that by inserting the splitter plate, the total pressure variation in Stages I and III is reduced. When the splitter plate is not provided, the total pressure variation caused by the Ferri buzz occurring in Stage III is typically large enough to restrict the engine operation. When, in consideration of this fact, an allowable value of an RMS value ΔPrms of the total pressure variation is envisaged as approximately 2% of a total pressure Po, the total pressure variation remains within the allowable range even in Stages I and III following insertion of the splitter plate according to the present invention, and as a result, a great enlargement of the stable operating range of the intake in which the engine operation is guaranteed can be confirmed.

It can be seen that in Stage II, which is a stable operating region, the total pressure variation conversely increases when the splitter plate is inserted (B in FIG. 6). In the case of Plate A in particular, the opening angle of the duct on the ramp side of the splitter plate increases, leading to large pressure variation in that location.

In Stage I (the supercritical operating condition), pressure variation is greatly suppressed by inserting the splitter plate (A in FIG. 6). In the supercritical operating condition, the flow captured by the intake does not vary, and the flow is regulated by variation in the total pressure recovery rate. Hence, in an operating condition in which the engine requires a larger flow, phenomena accompanying total pressure loss, such as shock wave generation and flow separation, are more likely to occur in the subsonic diffuser. When the splitter plate is not provided, therefore, large pressure variation occurs. When the splitter plate is inserted, on the other hand, although the splitter plate itself causes viscosity loss, the total pressure recovery rate is substantially equal to the operating condition of the intake.

Hence, the pressure loss caused by insertion of the splitter plate may be considered partially responsible for the flow regulation resulting from the total pressure loss in the supercritical operating condition. In other words, the phenomena accompanying pressure variation when the splitter plate is not provided, such as shock wave generation and flow separation, are suppressed, and it may therefore be considered that pressure variation is suppressed by the splitter plate.

When the flow ratio decreases in a subcritical operating condition, Ferri buzz is generated by an inflowing shear layer (Stage III), as described above, and in the absence of the splitter plate, therefore, large pressure variation occurs due to shock wave oscillation. When Plate A is inserted, on the other hand, the total pressure variation on the cowl side of the splitter plate, where the duct is rectilinear, decreases greatly (C in FIG. 6). It was found by observing shock wave oscillation on a high-speed video that in this case, shock wave oscillation is substantially suppressed. Meanwhile, the opening angle of the duct increases on the ramp side of the splitter plate, and therefore comparatively large total pressure variation believed to be a cause of flow separation occurs. However, an overall Ferri buzz suppression effect is large, and therefore the variation is reduced to a degree at which the engine operation can be guaranteed. It can be seen that when Plate B is inserted, the total pressure variation is suppressed overall (C in FIG. 6). However, although the opening angle of the duct on the cowl side of the splitter plate is halved in comparison with a case where the splitter plate is absent, an enlarged duct still exists, and therefore, as confirmed by the observation results of the high-speed video, shock wave oscillation, albeit small, does occur. The reason for this is that during a transition from Stage II to Stage III in FIG. 5, the total pressure variation increases in a step, similarly to a case in which the splitter plate is absent. The overall variation remains small, however, and it may therefore be said that the most stable intake condition is obtained in Stage III.

As regards temporal variation in the spatial distortion indices (a relationship between the radial direction index and the circumferential direction index), the indices represent a degree to which the total pressure in the radial direction or the circumferential direction deviates from an average value, and therefore the distortion indices increase as a dynamic pressure increases, or in other words as the operating condition shifts toward the supercritical operating condition. Further, a width of the temporal variation in the distortion indices substantially corresponds to the RMS value of the total pressure variation shown in FIG. 5 such that the amount of temporal variation in the spatial distortion increases as the total pressure variation increases. When the splitter plate is inserted, the amount of temporal variation in the spatial distortion changes little from Stage I to Stage III, regardless of whether Plate A or Plate B is used, and it can therefore be confirmed that a stable operation is realized likewise in terms of the spatial distortion.

It is evident from the results of the investigations described above that in terms of enlargement of the stable operating region of the intake and the total pressure recovery rate, a superior performance is exhibited when the duct is basically divided equally by inserting a splitter plate such as Plate B. Further, it was confirmed from the data described above that a slight correction is more effective in a case where bias exists in the effect of the flow through the divided duct, but when the cross-section of only one duct is varied using a splitter plate such as Plate A, large total pressure variation occurs in this duct, creating a need for cross-section variation likewise in the duct having a large effect. In actuality, the manner in which the duct is to be divided may be designed in accordance with the structure of each intake.

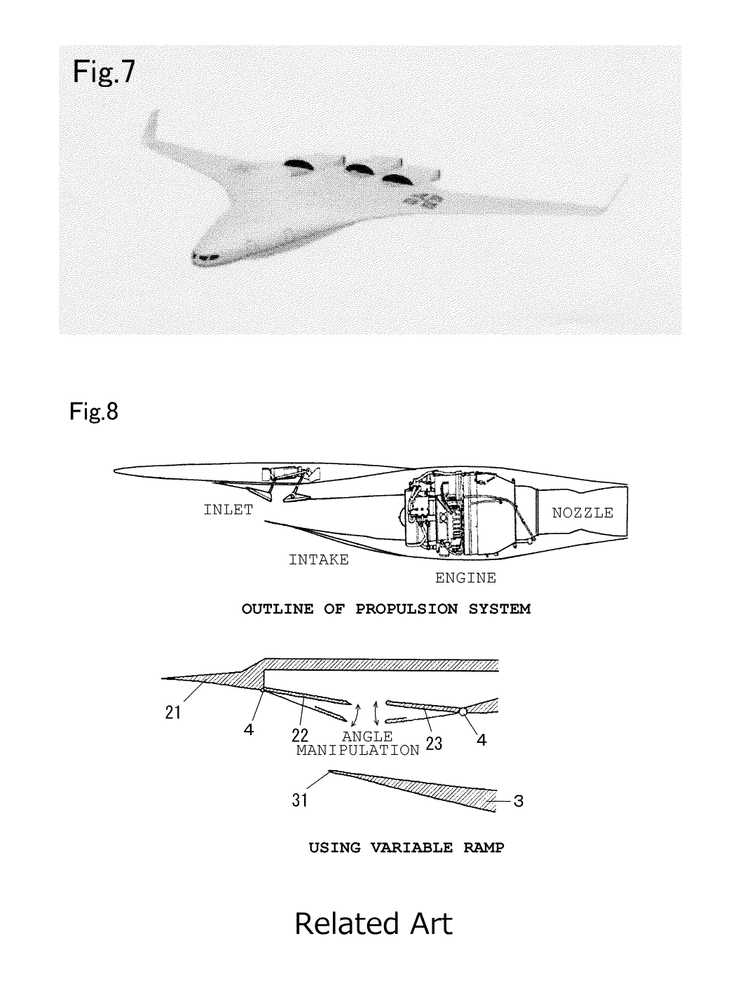

The present invention may be used in the aeronautical industry as a technique employed in particular in a supersonic propulsion system. As regards subsonic passenger aircraft, it may be possible to apply the present invention as a future concept to a case in which an airframe model at a proposal stage, such as that shown in FIG. 7, is highly integrated with an engine.

What is claimed is:

1. An operation stabilization method for a supersonic intake, wherein an enlarged duct between a cowl and a ramp of said intake is divided by a splitter plate such that an opening angle of said enlarged duct decreases.

2. The operation stabilization method for a supersonic intake according to claim 1, wherein, when said duct is divided by said splitter plate, said splitter plate is disposed such that, from among a cowl side duct and a ramp side duct, variation in one duct, in which an effect of a flow is larger, is reduced within an allowable range of total pressure loss in the other duct.

3. An operation stabilization apparatus for a supersonic intake, wherein a splitter plate that divides an enlarged duct between a cowl and a ramp of said intake is disposed on a downstream side of a bleed slit such that an opening angle of said enlarged duct decreases.

4. The operation stabilization apparatus for a supersonic intake according to claim 3, wherein said splitter plate is disposed such that said opening angle of said enlarged duct is equal on said cowl side and said ramp side of said intake.

5. The operation stabilization apparatus for a supersonic intake according to claim 3, wherein said splitter plate is disposed such that, from among a cowl side duct and a ramp side duct, variation in one duct, in which an effect of a flow is larger, is reduced within an allowable range of total pressure loss in the other duct.
